(19) United States
(12) Patent Application Publication
(10) Pub. No.: US 2002/0084654 A1
(43) Pub. Date: Jul. 4, 2002

(54) Resin connector

(76) Inventors: Kazutaka Katayama, Komaki-shi (JP); Akira Takayanagi, Nishikasugai-gun (JP); Hiroaki Ito, Kasugai-shi (JP); Tomohide Ito, Kasugai-shi (JP)

Correspondence Address: ARMSTRONG,WESTERMAN & HATTORI, LLP, 1725 K STREET, NW., SUITE 1000, WASHINGTON, DC, 20006, US

(21) Appl. No.: 09/975,303

(22) Filed: Oct. 12, 2001

(30) Foreign Application Priority Data
Oct. 12, 2000 (JP) 2000-312541
Sep. 19, 2001 (JP) 2001-285242

(51) Int. Cl. F16L 55/00; F16L 39/00

(52) U.S. Cl. 285/423; 285/319

(57) ABSTRACT

A resin connector having superior gasoline permeation resistance, particularly superior gasohol permeation resistance. The resin connector has a nearly cylindrical housing section in which one end portion is formed as an insert portion adapted to be inserted into the interior of a hose, and the other end portion is a container portion adapted to contain an engaging object member therein, and a pair of O rings, which function as seal members, incorporated in the housing section. The housing section is formed by molding resin composition having a following property (A):

(A) a volume change rate during immersion in gasohol of 5% or less.

### BACKGROUND OF THE INVENTION

1. Field of the Invention

The present invention relates to a resin connector used for transporting gasoline, especially gasohol (alcohol-containing gasoline), which is an automotive fuel.

2. Description of the Art

Hitherto, as a body (housing) of a connector used in piping to transport a fuel, for example, gasoline in an automobile, those bodies formed with high-strength synthetic resins, for example, polyamide 12 containing glass fibers, have been suggested (Japanese Unexamined Patent Application Publication No. 8-233181, etc.).

On the other hand, in recent years, environmental issues have come to the fore, and accompanying this, the regulations for gasoline permeation have been tightened. Under these circumstances and from the viewpoint of a groundwater pollution problem, the use of methyl-t-butyl ether (MTBE), which has been hitherto added to gasoline as an octane number improver, has been prohibited in the U.S. As an alternative thereto, the use of alcohols as gasoline additives has been researched.

Under such an environment, regarding connectors used in piping to transport gasoline as described above, molding compounds therefor are not specifically limited, and aliphatic nylons, for example, polyamide 12 and polyamide 66, polyacetals (POM), etc., have been used from the viewpoint only of moldability.

However, each of the aforementioned molding compounds has poor alcohol resistance as the volume thereof changes by a large degree with increase in gasohol permeation amounts. As a consequence, these compounds are not suitable as materials for connectors used in piping for transporting fuels of automobiles using gasohol as fuels. Therefore, a connector having superior gasohol permeation resistance (specifically, permeation amount of 10 mg/unit/day or less) has been required. Furthermore, a connector having superior moldability as well as the aforementioned permeation resistance, that is, having a high degree of flexibility in terms of the design for fuel piping, has been required.

### SUMMARY OF THE INVENTION

The present invention has been made in consideration of the aforementioned circumstances. Accordingly, it is an object of the present invention to provide a resin connector for fuel piping which has superior gasoline permeation resistance when gasohol is used as a fuel.

In order to achieve the aforementioned object, a resin connector according to the present invention has a nearly cylindrical housing section having a first end portion formed as an insert portion adapted to be inserted into the interior of a hose, and a second end portion formed as a container portion adapted to contain an engaging object member therein, and at least one seal member incorporated in the housing section, wherein the housing section is a molding of a resin composition having the following property (A):

(A) a volume change rate during immersion in gasohol of 5% or less.

The inventors of the present invention conducted research regarding resin connectors for fuel piping which have superior gasohol resistance when gasohol is used as a fuel. As a result of the research with emphasis on properties of a housing section of the resin connector from the viewpoint of the gasohol resistance, it has been discovered that when the housing section was formed from a molding of a resin composition having a volume change rate during immersion in gasohol of specified value or less, even if gasohol was used as a fuel, no problems occurred in the use thereof and thus the connector could be excellently used in a gasohol transfer portion of an automobile.

Furthermore, when the aforementioned housing section is formed from a resin composition primarily containing at least one resin selected from the group consisting of polyphenylene sulfides, polybutylene naphthalates, hydrocarbons having a carbon number of 9 and including amines at both terminals-terephthalic acid condensates, hexamethylenediamine-adipic acid-terephthalic acid condensates, hexamethylenediamine-isophthalic acid-terephthalic acid condensates, hexamethylenediamine-adipic acid-isophthalic acid-terephthalic acid condensates, m-xylylenediamine-adipic acid condensates, and liquid crystal polymers, superior gasohol permeation resistance can be achieved. Herein, the aforementioned “primarily containing” includes the situation where the resin composition consists of only the primary component.

When the electrical resistance of the molding of the resin composition forming the aforementioned housing section is a specified value or less, it is possible to alleviate static electricity that is generated due to fluid friction.

### BRIEF DESCRIPTION OF THE DRAWINGS

FIG. 1 is a front view, a part of which is a sectional view, of a resin connector according to an embodiment of the present invention.

FIG. 2 is a front view, a part of which is a sectional view, showing a resin connector according to an embodiment of the present invention connected to a hose.

FIG. 3 is a front view, a part of which is a sectional view, showing a pipe connected to a resin connector according to an embodiment of the present invention.

FIG. 4 is a schematic diagram showing a method for measuring the amount of fuel permeation of a resin connector.

### DESCRIPTION OF THE PREFERRED EMBODIMENTS

Next, embodiments according to the present invention will be described in detail.

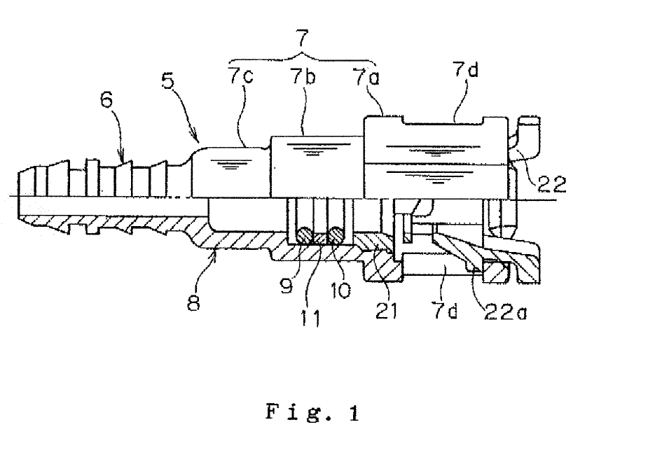

A resin connector 5 according to the present invention comprises, for example, as shown in FIG. 1, a housing section 8 having an insert portion 6 adapted to be inserted into the interior of a hose to be connected to the connector. The housing section 8 also has a container portion 7 to contain an engaging object member therein. The resin connector 5 further includes a first O ring 9 incorporated on the inner radius surface, at the insert portion 6 side, in the container portion 7, and a second O ring 10 incorporated on the inner radius surface, at the outlet side, in the aforementioned container portion 7, the O rings being seal members. On the exterior surface of the aforementioned insert portion 6, a plurality of ring-like protrusions are formed. The inside of the aforementioned container portion 7 is formed so as to have three portions, a first diameter portion 7a, a second diameter portion 7b, and a third diameter portion 7c, in order toward the inside, while the respective inner diameters of these portions stepwise decrease in this order. In FIG. 1, reference numeral 11 denotes a spacer provided between the aforementioned first O ring 9 and second O ring 10. Reference numeral 22 denotes a retainer for holding a pipe or the like. This retainer 22 is an engaging object member in the resin connector, and the retainer includes a pair of stopper portions 22a. These stopper portions 22a engage with openings 7d in housing section 8 so as to be removably held in the housing section. Furthermore, reference numeral 21 denotes a ring bushing having a hole through which the pipe or the like, (the engaging object member) is inserted, the bushing holding a pair of O rings 9 and 10 in the container portion 7. The ring bushing 21 fits in the container portion 7.

The housing section 8 of the aforementioned resin connector 5 is formed from a molding of a resin composition having the following property (A):

(A) volume change rate during immersion in gasohol of 5% or less.

The aforementioned property (A) means that when the aforementioned molding of resin composition is immersed in a fuel of 85% by volume of Fuel C (50% by volume of toluene +50by volume of isooctane) and 15% by volume of methanol at 60° C. for a period of 168 hours, the volume change rate is 5% or less. In particular, the volume change rate during immersion in gasohol is preferably 3.5% or less. That is, when the volume change rate exceeds 5%, the affinity between the material and the fuel is increased, so that the fuel permeation amount is increased.

Furthermore, it is preferable to use a resin having a heat distortion temperature of 150° C. or more at 1.85 MPa. By using such a resin, reliability in an engine compartment. When the temperature therein is too high, is increased. The measurement of the aforementioned heat distortion temperature is performed in conformity with ASTM D 648.

Examples of the resins for forming the resin composition having the aforementioned property (A) include, for example, polyphenylene sulfides (PPS), polybutylene naphthalates (PBN), polybutylene terephthalates (PBT), hydrocarbons having a carbon number of 9 and including amines at both terminals-terephthalic acid condensates (PA9T), hexamethylenediamine-adipic acid-terephthalic acid condensates, hexamethylenediamine-isophthalic acid-terephthalic acid condensates, hexamethylenediamine-adipic acid-isophthalic acid-terephthalic acid condensates (modified PA6T), m-xylylenediamine-adipic acid condensates, and liquid crystal polymers, as well as various fluororesins, e.g., ethylene-tetrafluoroethylene copolymer resins (ETFE), polyvinylidene fluorides (PVDF), polytetrafluoroethylenes (PTFE), and chlorotrifluoroethylenes (CTFE), and polypthalamides (PPA). These resins may be used alone, or at least two of these may be used concurrently. Among these, from the viewpoint of mechanical strength and small volume change due to gasohol exposure, it is especially preferable to use polyphenylene sulfides (PPS), polybutylene naphthalates (PBN), hydrocarbons having a carbon number of 9 and including amines at both terminals-terephthalic acid condensates (PA9T), hexamethylenediamine-adipic acid-isophthalic acid-terephthalic acid condensates (modified PA6T), and liquid crystal polymers.

The aforementioned resin composition may also contain electrically conductive agents, reinforcing agents, and other various additives.

Examples of the aforementioned electrically conductive agents include carbon nanotubes, carbon fibers, carbon black, metal powders, etc. The contents of these electrically conductive agents are preferably within the range of 2% to 18% by weight of the total resin composition. When the content exceeds 18% by weight, although the electrical conductivity is stabilized, the moldability of the housing section tends to be degraded.

Regarding the aforementioned resin composition, the electrical resistance of the molding thereof is preferably specified to be 10⁶Ω or less by including the aforementioned electrically conductive agent, etc. When the electrical resistance is 10⁶Ω or less, it is possible to alleviate static electricity that is generated due to fluid friction.

Examples of the aforementioned reinforcing agents include, for example, glass fibers and whiskers. The content of the aforementioned reinforcing agent is preferably within the range of 10% to 50% by weight of the total resin composition.

The material for forming the first O ring 9 which is incorporated on the inner radius surface, that is, at the hose insert portion 6 side, in the aforementioned container portion 7 is preferably, for example, fluororubber (FKM) and fluororesins.

The aforementioned first O ring 9 preferably has its surface coated with various electrically conductive elastomers. More preferably, the surface of the aforementioned first O ring 9 is coated with an elastomer having a volume resistivity of 10⁶Ω•cm or less.

As such an elastomer, those elastomers having flexibility at low temperatures, in which a peak of loss modulus (E″) is observed at −35° C. or less, and a storage modulus (E′) is 2×10⁵ N/cm² or less at −35° C., preferably are used. With elastomers having the aforementioned properties, a superior sealing property at low temperatures is achieved.

Specific examples of the aforementioned various elastomers include, for example, epichlorohydrin rubber (ECO), fluorosilicon rubber (FVMQ), and acrylic rubber (ACM).

The thickness of the aforementioned coating is preferably 4 to 50 μm.

Examples of the materials for forming the second O ring 10, which is incorporated on the inner radius surface at the outlet side in the aforementioned container portion 7, include, for example, FVMQ, ECO, and ACM. This material may be similar to those for the coated first O rings.

Furthermore, if necessary, the rubber materials which are used for forming the aforementioned first and second O rings may appropriately contain one or more processing aids, antioxidants, reinforcing agents, plasticizers, vulcanizing agents, vulcanization accelerators, vulcanization accelerating aids, retarders, fillers, etc.

Examples of the aforementioned processing aids include, for example, stearic acid, fatty acid esters, fatty acid amides, and hydrocarbon resins.

Examples of the aforementioned antioxidants include, for example, phenylenediamine antioxidants, phenolic antioxidants, diphenylamine antioxidants, quinoline antioxidants, and wax.

Examples of the aforementioned reinforcing agents include, for example, carbon black and white carbon.

Examples of the aforementioned plasticizers include, for example, phthalic acid plasticizers, e.g., dioctyl phthalate (DOP) and dibutyl phthalate (DBP), adipic acid plasticizers, e.g., dibutyl carbitol adipate and dioctyl adipate (DOA), and sebacic acid plasticizers, e.g., dioctyl sebacate (DOS) and dibutyl sebacate (DBS).

Examples of the aforementioned vulcanizing agents include, for example, polyamines, triazine compounds, polyols, metallic soaps, and peroxides.

Examples of the aforementioned vulcanization accelerators include, for example, thiourea accelerators, thiazole accelerators, thiuram accelerators, and sulphene amide accelerators.

Examples of the aforementioned vulcanization accelerating aids include, for example, activated zinc white, magnesium oxide, calcium oxide, and calcium hydroxide.

Examples of the aforementioned retarders include, for example, nitroso compounds.

Examples of the aforementioned fillers include, for example, calcium carbonate, magnesium carbonate, clay, and talc.

The resin connector according to the present invention can be produced, for example, as described below. That is, various additives, such as an electrically conductive agent, as necessary, are compounded with the resin which is the aforementioned material for molding, and these are mixed and injection-molded into a predetermined shape so as to produce a housing section. Each of the aforementioned first and second O rings, and a spacer to be interposed therebetween, are produced by a publicly known conventional method.

The size of the aforementioned housing section is appropriately based on the inner diameter of a hose in which the insert portion is inserted to engage the hose, and the outer diameter of a pipe to be contained in the container portion.

Subsequently, the first O ring and the second O ring are incorporated on the inner radius surface, at the hose insert portion side, in the container portion of the housing section produced as described above, and on the inner radius surface, at the container portion outlet side of the housing section, respectively, with a spacer therebetween so as to produce the resin connector (refer to FIG. 1). Alternatively, another first O ring may be used instead of the aforementioned spacer (that is, three O rings are used in total).

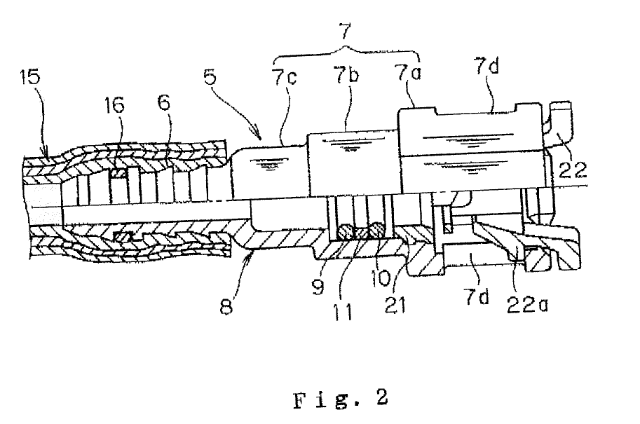

For example, as shown in FIG. 2, the resin connector according to the present invention can be connected to a hose 15 by inserting the insert portion 6 having a plurality of ring-like protrusions formed thereon into an end portion of the hose 15 having a three-layered structure. In FIG. 2, reference numeral 16 denotes an O ring provided between the hose 15 and the resin connector 5.

When the resin connector 5 is inserted into the aforementioned hose 15 so as to engage the hose, a press- fitting operation using a compressing force of the hose 15 is performed. If necessary, an elastic coating material or a sealing material, other than the aforementioned O ring 16, can be used between the hose 15 and the resin connector 5.

As the material for forming the aforementioned O ring 16, materials similar to those for forming the aforementioned first O ring 9 and second O ring 10 preferably may be used, and more preferably, the same material as those for forming the first O ring 9 may be used.

Examples of the aforementioned elastic coating materials include, for example, halogenated butyl rubbers, e.g., chlorinated butyl rubber (Cl-IIR), brominated butyl rubber (Br-IIR), NBR, hydrogenated NBR (H-NBR), NBR/polyvinyl chloride (PVC), chloroprene rubber (CR), FVMQ, ECO, ACM, and FKM.

Examples of the aforementioned sealing materials include, for example, FKM, and fluororesins containing the aforementioned coating materials.

Regarding the resin connector according to the present invention, a hose is connected to the insert portion at one end of the resin connector, and a pipe which is an engaging object member is connected to the container portion at the other end of the resin connector by direct pressure-fitting.

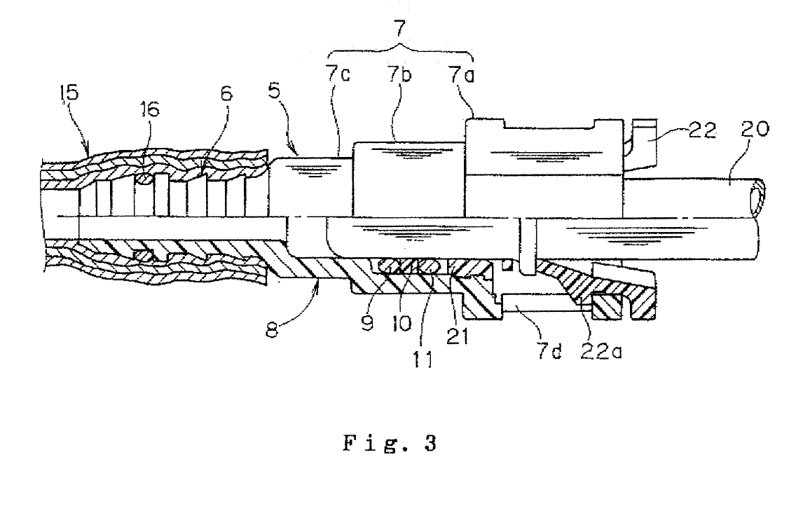

The resin connector according to the present invention is used, for example, in a structure as described below. That is, as shown in FIG. 3, the hose 15 is connected to the insert portion 6 of the aforementioned resin connector 5, and a pipe 20 is inserted into the container portion 7 of the resin connector, so that the hose 15 and the pipe 20 are connected to each other by the resin connector 5 according to the present invention located therebetween. The retainer 22 fits on the perimeter of the end portion of the aforementioned pipe 20, and the pair of stopper portions 22a provided on the retainer 22 engage the openings 7d provided in the container portion 7 so as to be removably held in the housing section 8.

The resin connector according to the present invention is preferably used for, for example, a connecting part of a fuel transport system of an automobile which uses gasohol as a fuel.

Next, Examples will be described together with Comparative Examples.

### EXAMPLE 1

Production of Housing Section and Two Kinds of O rings

As a material for forming a housing section, PPS (manufactured by DAINIPPON INK AND CHEMICALS, INCORPORATED, FZ-2200-A5) was used. As materials for forming the two kinds of O rings, FKM was used as the material for forming the first O ring (manufactured by DAIKIN INDUSTRIES, LTD., DAI-EL G556) and FVMQ was used as the material for forming the second O ring (manufactured by SHIN-ETSU CHEMICAL CO., LTD., FE251K-U).

The housing section 8 having a shape shown in FIG. 1 was formed using the aforementioned material for forming a housing section, PPS, by injection molding (molding conditions: Z1=330° C., Z2=340° C., Z3 =340° C., and nozzle=320° C.)

Two O rings were produced using the aforementioned materials, FKM (the material for forming the first O ring) and FVMQ (the material for forming the second O ring) by molding. The molding conditions were at 170° C.×10 minutes for press vulcanization, and at 200° C. in an air oven ×16 hours for after-cure so as to produce the two O rings.

Subsequently, the first O ring(outer diameter of 11 mm) and the second O ring (outer diameter of 11 mm) were incorporated on the inner radius surface, at the hose insert portion side, in the container portion of the aforementioned housing section, and on the inner radius surface, at the outlet side, in the aforementioned container portion, respectively, with a spacer made of polyphthalamide therebetween, so as to produce the resin connector 5 shown in FIG. 1.

A retainer made of polyamide 6-12 and a bush made of polyphthalamide were produced by publicly known methods.

### EXAMPLE 2

Production of Housing Section and Two Kinds of O rings

As a material for forming a housing section, PPS (manufactured by DAINIPPON INK AND CHEMICALS, INCORPORATED, Z230) containing 30% by weight of glass fiber was prepared, As materials for forming the two kinds of O rings, FKM was used as the material for forming the first O ring (manufactured by DAIKIN INDUSTRIES, LTD., DAI-EL G556) and FVMQ was used as the material for forming the second O ring (manufactured by SHIN-ETSU CHEMICAL CO., LTD., FE251K-U).

The housing section 8 having a shape shown in FIG. 1 was formed using the aforementioned material for forming a housing section, PPS containing glass fiber, by injection molding (molding conditions: Z1=330° C., Z2=340° C., Z3=340° C., and nozzle=330° C.)

Two O rings were produced using the aforementioned materials for forming the two kinds of O rings, FKM (the material for forming the first O ring) and FVMQ (the material for forming the second O ring) by molding. The molding conditions were at 170° C.×10 minutes for press vulcanization, and at 200° C. in an air oven×16hours for after-cure so as to produce the two O rings. The surface of the O ring made of FKM (the material for forming the first O ring) of the aforementioned two O rings was coated to a thickness of 20 μm with ECO (manufactured by ZEON CORPORATION, Gechron 3105).

Subsequently, the first O ring (outer diameter of 11 mm) and the second O ring (outer diameter of 11 mm) were incorporated on the inner radius surface, at the hose insert portion side, in the container portion of the aforementioned housing section, and on the inner radius surface, at the outlet side, in the aforementioned container portion, respectively, with a spacer made of polyphthalamide therebetween so as to produce the resin connector 5 shown in FIG. 1.

A retainer made of polyamide 6-12 and a bush made of polyphthalamide were produced by publicly known methods.

### EXAMPLE 3

Production of Housing Section and Two Kinds of O rings

As a material for forming a housing section, PPS (manufactured by DAINIPPON INK AND CHEMICALS, INCORPORATED, FZ-2200-A5) containing 10% by weight of glass fiber (manufactured by Nitto Boseki Co., Ltd., T-GLASS) and 10% by weight of carbon fiber (manufactured by Toray Industries, Ltd., Torayca T300) was used. As materials for forming the two kinds of O rings, FKM was used as the material for forming the first O ring (manufactured by DAIKIN INDUSTRIES, LTD., DAI-EL G556) and FVMQ was used as the material for forming the second O ring (manufactured by SHIN-ETSU CHEMICAL CO., LTD., FE251K-U).

The housing section 8 having a shape shown in FIG. 1 was formed using the aforementioned material for forming a housing section, that is, PPS containing glass fiber, by injection molding (molding conditions: Z1=330° C., Z2=340° C., Z3=340° C., and nozzle=320° C.)

The two O rings were produced using the aforementioned materials for forming the two kinds of O rings, FKM (the material for forming the first O ring) and FVMQ (the material for forming the second O ring) by molding. The molding conditions were at 170° C.×10 minutes for press vulcanization, and at 200° C. in an air oven×16hours for after-cure so as to produce the two O rings. The surface of the O ring made of FKM (the material for forming the first O ring) of the aforementioned two O rings was coated to a thickness of 20 μm with an electrically conductive FVMQ (manufactured by SHIN-ETSU CHEMICAL CO., LTD., FE251K-U) which contained 20% of DENKA BLACK (manufactured by DENKI KAGAKU KOGYO KABUSHIKI KAISHA).

Subsequently, the first O ring (outer diameter of 11 mm) and the second O ring (outer diameter of 11 mm) were incorporated on the inner radius surface, at the hose insert portion side, in the container portion of the aforementioned housing section, and on the inner radius surface, at the outlet side, in the aforementioned container portion, respectively, with a spacer made of polyphthalamide therebetween so as to produce the resin connector 5 shown in FIG. 1.

A retainer made of polyamide 6-12 and a bush made of polyphthalamide were produced by publicly known methods.

### EXAMPLE 4

Production of Housing Section and Two Kinds of O rings

As a material for forming a housing section, PBN (manufactured by Toyobo Co., Ltd., PELPRENE) containing 30% by weight of glass fiber (manufactured by Nitto Boseki Co., Ltd., T-GLASS) was used. As materials for forming the two kinds of O rings, FKM was used as the material for forming the first O ring (manufactured by DAIKIN INDUSTRIES, LTD., DAI-EL G556) and FVMQ was used as the material for forming the second O ring (manufactured by SHIN-ETSU CHEMICAL CO., LTD., FE251K-U).

The housing section 8 having a shape shown in FIG. 1 was formed using the aforementioned material for forming a housing section, that is, PBN containing glass fiber, by injection molding (molding conditions: Z1 260° C., Z2 280° C., Z3 290° C., and nozzle 280° C.).

Two O rings were produced using the aforementioned materials for forming the two kinds of O rings, FKM (the material for forming the first O ring) and FVMQ (the material for forming the second O ring) by molding. The molding conditions were at 170° C.×10 minutes for press vulcanization, and at 200° C. in an air oven×16hours for after-cure so as to produce two O rings. The surface of the O ring made of FKM (the material for forming the first O ring) of the aforementioned two O rings was coated to a thickness of 20 μm with ACM (manufactured by DENKI KAGAKU KOGYO KABUSHIKI KAISHA, ER-3400).

Subsequently, the first O ring(outer diameter of 11 mm) and the second O ring (outer diameter of 11 mm) were incorporated on the inner radius surface, at the hose insert portion side, in the container portion of the aforementioned housing section, and on the inner radius surface, at the outlet side, in the aforementioned container portion, respectively, with a spacer made of polyphthalamide therebetween so as to produce the resin connector 5 shown in FIG. 1.

A retainer made of polyamide 6-12 and a bush made of polyphthalamide were produced by publicly known methods.

### EXAMPLE 5

As a material for forming a housing section, PBN (manufactured by Toyobo Co., Ltd., PELPRENE) containing 20% by weight of glass fiber (manufactured by Nitto Boseki Co., Ltd., T-GLASS) and 10% by weight of carbon fiber (manufactured by Toray Industries, Ltd., Torayca T300) was used. The combination of O rings was the same as that in Example 3. The resin connector 5 shown in FIG. 1 was produced in a manner similar to that in Example 4 except for the aforementioned matters.

A retainer made of polyamide 6-12 and a bush made of polyphthalamide were produced by publicly known methods.

### EXAMPLE 6

As a material for forming a housing section, PBN (manufactured by Toyobo Co., Ltd., PELPRENE) containing 30% by weight of glass fiber (manufactured by Nitto Boseki Co., Ltd., T-GLASS) and 3% by weight of carbon nanotube (manufactured by Hyperion Catalysis International, Inc., Hyperion) was used. The resin connector was produced in a manner similar to that in Example 5 except for the aforementioned matter.

A retainer made of polyamide 6-12 and a bush made of polyphthalamide were produced by publicly known methods.

### EXAMPLE 7

As a material for forming a housing section, PBN (manufactured by Toyobo Co., Ltd., PELPRENE) containing 20% by weight of glass fiber (manufactured by Nitto Boseki Co., Ltd., T-GLASS) and 7% by weight of carbon black (manufactured by Akzo Novel, Ketchen black EC) was used. The resin connector was produced in a manner similar to that in Example 5 except for the aforementioned matter.

A retainer made of polyamide 6-12 and a bush made of polyphthalamide were produced by publicly known methods.

### EXAMPLE 8

As a material for forming a housing section, PPA (manufactured by Amoco Polymers Inc., Amodel AS4133HS) containing 33% by weight of glass fiber was used. The housing section 8 having a shape shown in FIG. 1 was formed by injection molding (molding conditions: Z1=320° C., Z2=330° C., Z3=335° C., and nozzle=325° C.). The resin connector was produced in a manner similar to that in Example 4 except for the aforementioned matters.

A retainer made of polyamide 6-12 and a bush made of polyphthalamide were produced by publicly known methods.

### EXAMPLE 9

As a material for forming a housing section, PPS (manufactured by DAINIPPON INK AND CHEMICALS, INCORPORATED, Z230) containing 4% by weight of carbon nanotube (manufactured by Hyperion Catalysis International, Inc., Hyperion) and 30% by weight of glass fiber was prepared. As materials for forming the two kinds of O rings, FKM was used as the material for forming the first O ring (manufactured by DAIKIN INDUSTRIES, LTD., DAI-EL G556) and FVMQ was used as the material for forming the second O ring (manufactured by SHIN-ETSU CHEMICAL CO., LTD., FE251K-U). The surface of the O ring made of FKM (the material for forming the first O ring) of the two O rings was coated to a thickness of 20 μm with electrically conductive FVMQ (manufactured by SHIN-ETSU CHEMICAL CO., LTD., FE251K-U) containing 20% of DENKA BLACK (manufactured by DENKI KAGAKU KOGYO KABUSHIKI KAISHA). The resin connector 5 shown in FIG. 1 was produced in a manner similar to that in Example 2 except for the aforementioned matters.

A retainer made of polyamide 6-12 and a bush made of polyphthalamide were produced by publicly known methods.

### EXAMPLE 10

As a material for forming a housing section, PPS (manufactured by DAINIPPON INK AND CHEMICALS, INCORPORATED, Z230) containing 30% by weight of glass fiber was used. A seal member was injection molded (190° C.×5 minutes) and subjected to after-cure (200° C.×10 hours) using FKM (manufactured by DAIKIN INDUSTRIES, LTD., DAI-EL G556) to form a seal member in which two O rings and a spacer were integrated. The resin connector 5 shown in FIG. 1 was produced in a manner similar to that in Example 2 except for the aforementioned matters.

A retainer made of polyamide 6-12 and a bush made of polyphthalamide were produced by publicly known methods.

### EXAMPLE 11

As a material for forming a housing section, PA9T (manufactured by Kuraray Co., Ltd., Genestar G1300NA) containing 30% by weight of glass fiber was used. As materials for forming the two kinds of O rings, FKM was used as the material for forming the first O ring (manufactured by DAIKIN INDUSTRIES, LTD., DAI-EL G556) and FVMQ was used as the material for forming the second O ring (manufactured by SHIN-ETSU CHEMICAL CO., LTD., FE251K-U).

The housing section 8 having a shape shown in FIG. 1 was formed using the aforementioned material for forming the housing section, that is, PA9T containing glass fiber, by injection molding (molding conditions: Z1=310° C., Z2=330° C., Z3 =335° C., and nozzle=330° C.). The resin connector 5 shown in FIG. 1 was produced in a manner similar to that in Example 1 except for the aforementioned matters.

A retainer made of polyamide 6-12 and a bush made of polyphthalamide were produced by publicly known methods.

### EXAMPLE 12

As a material for forming a housing section, a hexamethylenediamine-isophthalic acid-terephthalic acid condensate (manufactured by Mitsui Chemicals, Inc., ARLEN A335) containing 35% by weight of glass fiber was prepared. As materials for forming the two kinds of O rings, FKM was used as the material for forming the first O ring (manufactured by DAIKIN INDUSTRIES, LTD., DAI-EL G556) and FVMQ was used as the material for forming the second O ring (manufactured by SHIN-ETSU CHEMICAL CO., LTD., FE251K-U).

The housing section 8 having a shape shown in FIG. 1 was formed using the aforementioned material for forming the housing section, that is, the hexamethylenediamine-isophthalic acid-terephthalic acid condensate containing glass fiber, by injection molding (molding conditions: Z1=320° C., Z2=330° C., Z3=335° C, and nozzle=330° C.). The resin connector 5 shown in FIG. 1 was produced in a manner similar to that in Example 1 except for the aforementioned matters.

A retainer made of polyamide 6-12 and a bush made of polyphthalamide were produced by publicly known methods.

### EXAMPLE 13

As a material for forming a housing section, a hexamethylenediamine-adipic acid-terephthalic acid condensate (manufactured by Mitsui Chemicals, Inc., ARLEN C230) containing 30% by weight of glass fiber was prepared. As materials for forming the two kinds of O rings, FKM was used as the material for forming the first O ring (manufactured by DAIKIN INDUSTRIES, LTD., DAI-EL G556) and FVMQ was use as the material for forming the second O ring (manufactured by SHIN-ETSU CHEMICAL CO., LTD., FE251K-U).

The housing section 8 having a shape shown in FIG. 1 was formed using the aforementioned material for forming the housing section, that is, the hexamethylenediamine-adipic acid-terephthalic acid condensate containing glass fiber, by injection molding (molding conditions: Z1=320° C., Z2=330° C., Z3=335° C., and nozzle=330° C.). The resin connector 5 shown in FIG. 1 was produced in a manner similar to that in Example 1 except for the aforementioned matters.

A retainer made of polyamide 6-12 and a bush made of polyphthalamide were produced by publicly known methods.

### EXAMPLE 14

As a material for forming a housing section, a liquid polymer (manufactured by DAINIPPON INK AND CHEMICALS, INCORPORATED, OCTA LA-130) containing 30% by weight of glass fiber was prepared. As materials for forming the two kinds of O rings, FKM was used as the material for forming the first O ring (manufactured by DAIKIN INDUSTRIES, LTD., DAI-EL G556) and FVMQ was used as the material for forming the second O ring (manufactured by SHIN-ETSU CHEMICAL CO., LTD., FE251K-U).

The housing section 8 having a shape shown in FIG. 1 was formed using the aforementioned material for forming the housing section, that is, the liquid polymer containing glass fiber, by injection molding (molding conditions: Z1=330° C., Z2 340° C., Z3=350° C., and nozzle=340° C.). The resin connector 5 shown in FIG. 1 was produced in a manner similar to that in Example 1 except for the aforementioned matters.

A retainer made of polyamide 6-12 and a bush made of polyphthalamide were produced by publicly known methods.

### EXAMPLE 15

As a material for forming a housing section, an electrically conductive liquid polymer (manufactured by DAINIPPON INK AND CHEMICALS, INCORPORATED, OCTA LA-830) was used. As materials for forming the two kinds of O rings, FKM was used as the material for forming the first O ring (manufactured by DAIKIN INDUSTRIES, LTD., DAI-EL G556) and FVMQ was used as the material for forming the second O ring (manufactured by SHIN-ETSU CHEMICAL CO., LTD., FE251K-U). The surface of the O ring made of FKM (the material for forming the first O ring) of the two O rings was coated to a thickness of 20 μm with electrically conductive FVMQ (manufactured by SHIN-ETSU CHEMICAL CO., LTD., FE251K-U) containing 20% of DENKA BLACK (manufactured by DENKI KAGAKU KOGYO KABUSHIKI KAISHA).

The housing section 8 having a shape shown in FIG. 1 was formed using the aforementioned material for forming the housing section, that is, the electrically conductive liquid polymer, by injection molding (molding conditions: Z1=330° C., Z2=350° C., Z3=355° C., and nozzle=350° C.). The resin connector 5 shown in FIG. 1 was produced in a manner similar to that in Example 1 except for the aforementioned matters.

A retainer made of polyamide 6-12 and a bush made of polyphthalamide were produced by publicly known methods.

### EXAMPLE 16

As a material for forming a housing section, PA9T (manufactured by Kuraray Co., Ltd., Genestar), glass fiber (manufactured by Nitto Boseki Co., Ltd., T-GLASS) and carbon fiber (manufactured by Toray Industries, Ltd., Torayca T300) were kneaded using a twin screw extruder (manufactured by Kobe Steel, Ltd., Hyper-KTX46), at a kneading temperature of 335° C. so as to prepare PA9T containing 10% by weight of glass fiber and 15% by weight of carbon fiber. As materials for forming the two kinds of O rings, FKM was used as the material for forming the first O ring (manufactured by DAIKIN INDUSTRIES, LTD., DAI-EL G556) and FVMQ was used as the material for forming the second O ring (manufactured by SHIN-ETSU CHEMICAL CO., LTD., FE251K-U). The surface of the O ring made of FKM (the material for forming the first O ring) of the two O rings was coated to a thickness of 20 μm with electrically conductive FVMQ (manufactured by SHIN-ETSU CHEMICAL CO., LTD., FE251K-U) containing 20% of DENKA BLACK (manufactured by DENKI KAGAKU KOGYO KABUSHIKI KAISHA).

The housing section 8 having a shape shown in FIG. 1 was formed using the aforementioned material for forming the housing section, that is, PA9T containing glass fiber and carbon fiber, by injection molding (molding conditions: Z1=320° C., Z2=330° C., Z3=335° C., and nozzle=330° C.). The resin connector 5 shown in FIG. 1 was produced in a manner similar to that in Example 1 except for the aforementioned matters.

A retainer made of polyamide 6-12 and a bush made of polyphthalamide were produced by publicly known methods.

### EXAMPLE 17

As a material for forming a housing section, PA9T (manufactured by Kuraray Co., Ltd., Genestar), glass fiber (manufactured by Nitto Boseki Co., Ltd., T-GLASS) and carbon fiber (manufactured by Toray Industries, Ltd., Torayca T300) were kneaded using a twin screw extruder (manufactured by Kobe Steel, Ltd., Hyper-KTX46), at a kneading temperature of 335° C. so as to prepare PA9T containing 10% by weight of glass fiber and 15% by weight of carbon fiber. As materials for forming three kinds of O rings, FKM was used as the material for forming the first O ring (manufactured by DAIKIN INDUSTRIES, LTD., DAI-EL G556), FKM was used as the material for forming the second O ring (manufactured by DAIKIN INDUSTRIES, LTD., DAI-EL G556) instead of the spacer, and FVMQ was used as the material for forming the third O ring (manufactured by SHIN-ETSU CHEMICAL CO., LTD., FE251K-U). The surface of the second O ring made of FKM (the material for forming the second O ring) among the three O rings was coated to a thickness of 20 μm with electrically conductive FVMQ (manufactured by SHIN-ETSU CHEMICAL CO., LTD., FE251K-U) containing 20% of DENKA BLACK (manufactured by DENKI KAGAKU KOGYO KABUSHIKI KAISHA).

The housing section 8 having a shape shown in FIG. 1 was formed using the aforementioned material for forming the housing section, that is, PA9T containing glass fiber and carbon fiber, by injection molding (molding conditions: Z1=320°C., Z2=330° C., Z3=335° C., and nozzle=330° C.). The resin connector 5 shown in FIG. 1 was produced in a manner similar to that in Example 1 except for the aforementioned matters.

A retainer made of polyamide 6-12 and a bush made of polyphthalamide were produced by publicly known methods.

### EXAMPLE 18

As a material for forming a housing section, PA9T (manufactured by Kuraray Co., Ltd., Genestar), glass fiber (manufactured by Nitto Boseki Co., Ltd., T-GLASS) and carbon fiber (manufactured by Toray Industries, Ltd., Torayca T300) were kneaded using a twin screw extruder (manufactured by Kobe Steel, Ltd., Hyper-KTX46), at a kneading temperature of 335° C. so as to prepare PA9T containing 10% by weight of glass fiber and 15% by weight of carbon fiber. As materials for forming three kinds of O rings, THV was used as the material for forming the first O ring (manufactured by Dyneon, THV200), FKM was used as the material for forming the second O ring (manufactured by DAIKIN INDUSTRIES, LTD., DAI-EL G556) instead of the spacer, and FVMQ was used as the material for forming the third O ring (manufactured by SHIN-ETSU CHEMICAL CO., LTD., FE251K-U). The surface of the second O ring made of FKM (the material for forming the second O ring) among the three O rings was coated to a thickness of 20 μm with electrically conductive FVMQ (manufactured by SHIN-ETSU CHEMICAL CO., LTD., FE251K-U) containing 20% of DENKA BLACK (manufactured by DENKI KAGAKU KOGYO KABUSHIKI KAISHA).

The housing section 8 having a shape shown in FIG. 1 was formed using the aforementioned material for forming the housing section, that is, PA9T containing glass fiber and carbon fiber, by injection molding (molding conditions: Z1=320° C., Z2=330° C., Z3=335° C., and nozzle=330° C.). The first O ring was produced using the aforementioned material for forming the first O ring, THV, by injection molding (molding conditions: Z1=170° C., Z2=190° C., Z3=200° C., and nozzle=190° C.). The resin connector 5 shown in FIG. 1 was produced in a manner similar to that in Example 1 except for the aforementioned matters.

A retainer made of polyamide 6-12 and a bush made of polyphthalamide were produced by publicly known methods.

### COMPARATIVE EXAMPLE 1

As a material for forming a housing section, a polyamide resin (manufactured by ATOFINA, Rilsan AZM30NOIR T6LD) containing 30% by weight of glass fiber was used. A resin connector was produced in a manner similar to that in Example 1 except for the aforementioned matter.

A retainer made of polyamide 6-12 and a bush made of polyphthalamide were produced by publicly known methods.

### COMPARATIVE EXAMPLE 2

As a material for forming a housing section, a polyamide resin (manufactured by ATOFINA, Rilsan AMN) containing 15% by weight of carbon fiber (manufactured by Toray Industries, Ltd., Torayca T300) was used. A resin connector was produced in a manner similar to that in Example 1 except for the aforementioned matter.

A retainer made of polyamide 6-12 and a bush made of polyphthalamide were produced by publicly known methods.

### COMPARATIVE EXAMPLE 3

As a material for forming a housing section, a polyamide resin (manufactured by ATOFINA, Rilsan AMN) containing 15% by weight of glass fiber (manufactured by Nitto Boseki Co., Ltd., T-GLASS) and 10% by weight of carbon fiber (manufactured by Toray Industries, Ltd., Torayca T300) was used. A resin connector was produced in a manner similar to that in Example 1 except for the aforementioned matter.

A retainer made of polyamide 6-12 and a bush made of polyphthalamide were produced by publicly known methods.

### COMPARATIVE EXAMPLE 4

As a material for forming a housing section, a polyamide resin (manufactured by DuPont, Zytel 101) was used. A resin connector was produced in a manner similar to that in Example 1 except for the aforementioned matter.

A retainer made of polyamide 6-12 and a bush made of polyphthalamide were produced by publicly known methods.

### COMPARATIVE EXAMPLE 5

As a material for forming a housing section, POM (manufactured by Polyplastic Co., Ltd., DURACON M90-44) containing 10% by weight of carbon fiber (manufactured by Toray Industries, Ltd., Torayca T300) was used. A resin connector was produced in a manner similar to that in Example 1 except for the aforementioned matter.

A retainer made of polyamide 6-12 and a bush made of polyphthalamide were produced by publicly known methods.

### COMPARATIVE EXAMPLE 6

As a material for forming a housing section, HDPE (manufactured by Japan Polyolefins Co., Ltd., S5003BH) containing 10% by weight of carbon fiber (manufactured by Toray Industries, Ltd., Torayca T300) was used. A resin connector was produced in a manner similar to that in Example 1 except for the aforementioned matter.

A retainer made of polyamide 6-12 and a bush made of polyphthalamide were produced by publicly known methods.

### COMPARATIVE EXAMPLE 7

As a material for forming a housing section, a polyamide 66 (manufactured by Asahi Kasei Corporation, Leona 14G50) containing 50% by weight of glass fiber was used. A resin connector was produced in a manner similar to that in Example 1 except for the aforementioned matter.

A retainer made of polyamide 6-12 and a bush made of polyphthalamide were produced by publicly known methods.

Regarding the aforementioned Examples and Comparative Examples, values for gasohol volume change rate, fuel permeation amount of the resin connector, and inner surface resistance of housing section were measured and evaluated based on the following methods. The results thereof are collectively shown in Tables 1 to 4 described below. The values were determined according to the following procedures:

Gasohol Volume Change Rate

A sheet of 25 mm×20 mm×1 mm in thickness was formed using each of the aforementioned material for forming a housing section under the same conditions as those of the aforementioned injection molding. Subsequently, the each sheet was subjected to an immersion treatment for 168 hours in a fuel of 85% by volume of Fuel C. (50% by volume of toluene +50% by volume of isooctane) and 15% by volume of methanol at 60° C. The volume before and after the immersion treatment was measured, and a volume change rate was calculated based on the values thereof.

Fuel Permeation Amount

O rings were set into two connectors having a inner diameter of 11 mm, and thereafter, in order to prevent the O rings from dropping therefrom, polyphthalamide bushes having outer diameter of 11.05 mm×inner diameter of 10 mm were press-fitted into the connectors.

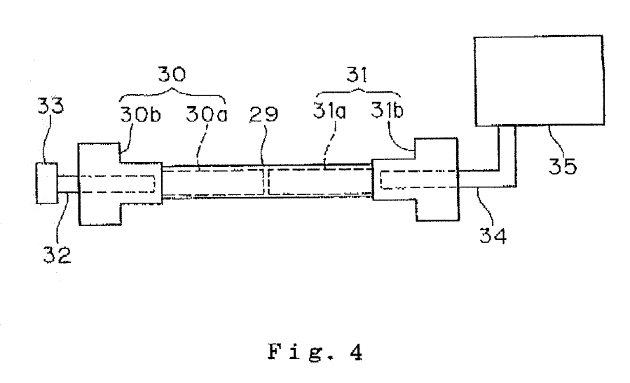

Subsequently, as shown in FIG. 4, insertion portions 30a and 31a of the two resin connectors 30 and 31 each were press-fitted into ends of PTFE tube 29. During press-fitting, the insertion portions 30a and 31a of the resin connectors 30 and 31 were made to contact each other within the PTFE tube 29 so that there was no parts in contact with liquid regarding the PTFE tube 29. One end of a metal pipe 32 having an outer diameter of 8 mm was inserted in a container portion 30b of one connector 30 of the aforementioned two resin connectors 30 and 31, and the other end of the metal pipe 32 was tightly blocked with a stopper 33. One end of a metal pipe 34 having an outer diameter of 8 mm was inserted into a container portion 31b of the other resin connector 31 and was fixed, while the other end of the pipe 34 was provided with a metal tank 35 capable of containing 100 cc of liquid.

Fuel C. containing 15% by volume of methanol was put in the aforementioned metal tank 35 so that the interiors of the resin connectors 30 and 31 were filled with Fuel C, and pretreatment was performed in an atmosphere at 60° C. for one week. Subsequently, permeation amount in the second week was measured based on the change of the weight.

Inner Surface Resistance of Housing Section

The measurement was performed in conformity with GM213 method. That is, copper circular cylinders having a diameter 0.05 to 0.1 mm greater than the inner diameter (d mm) of the housing section (length of L mm) of the connector were inserted into both ends of the housing section with a depth of a mm so as to measure the electrical resistance R (Ω). From the results thereof, the inner surface resistance Rs (Ω) of the housing section was calculated based on the following formula.

Rs(Ω)=R·π/(L−2a)

TABLE 1

| | Example | | | | | | | |
|---|---|---|---|---|---|---|---|---|
| | 1 | 2 | 3 | 4 | 5 | 6 | 7 | 8 |
| Gasohole | +3.3 | +2.2 | +2.5 | +3.0 | +2.8 | +2.9 | +3.2 | +5.0 |
| volume change | | | | | | | | |
| rate (%) | | | | | | | | |
| Fuel Perme- | 7.3 | 7.2 | 7.4 | 7.5 | 7.4 | 7.5 | 7.6 | 9.2 |
| ation amount | | | | | | | | |
| (mg/unit/day) | | | | | | | | |
| Inner surface | 2 × | 5 × | 5 × | 5× | 3 × | 1 × | 8 × | 2 × |
| resistance of | 10¹³ | 10¹³ | 10⁴ | 10¹³ | 10⁴ | 10⁴ | 10⁴ | 10¹³ |
| housing section | | | | | | | | |
| (Ω) | | | | | | | | |

TABLE 2

| | Example | | | | | | | |
|---|---|---|---|---|---|---|---|---|
| | 9 | 10 | 11 | 12 | 13 | 14 | 15 | 16 |
| Gasohole | +2.2 | +2.2 | +3.9 | +2.1 | +2.2 | +0.5 | +0.8 | +4.1 |
| volume change | | | | | | | | |
| rate (%) | | | | | | | | |
| Fuel Perme- | 7.3 | 7.3 | 5.8 | 5.5 | 5.7 | 4.9 | 5.2 | 6.2 |
| ation amount | | | | | | | | |
| (mg/unit/day) | | | | | | | | |
| Inner surface | 6 × | 5 × | 7 × | 6 × | 6 × | 9 × | 4 × | 3 × |
| resistance of | 10 ⁴ | 10¹³ | 10¹⁴ | 10¹³ | 10¹³ | 10¹⁴ | 10⁴ | 10⁴ |
| housing section | | | | | | | | |
| (Ω) | | | | | | | | |

TABLE 3

Example

| | 17 | 18 |
|---|---|---|
| Gasohole volume change | +4.1 | +4.1 |
| rate (%) | | |
| Fuel Permeation amount | 1.5 | 1.0 |
| (mg/unit/day) | | |
| Inner surface | 1 × | 3 × |
| resistance of housing | 10⁴ | 10⁴ |
| section (Ω) | | |

TABLE 4

| | Comparative Example | | | | | | |
|---|---|---|---|---|---|---|---|
| | 1 | 2 | 3 | 4 | 5 | 6 | 7 |
| Gasohole | +10.8 | +12.9 | +11.8 | +10.5 | +7.2 | +12.2 | +5.5 |
| volume change | | | | | | | |
| rate (%) | | | | | | | |
| Fuel Perme- | 14.2 | 17.1 | 14.8 | 57.0 | 17.4 | 45.7 | 48.2 |
| ation amount | | | | | | | |
| (mg/unit/day) | | | | | | | |
| Inner surface | 7 × | 6 × | 7 × | 1 × | 3 × | 4 × | 6 × |
| resistance of | 10¹² | 10⁴ | 10⁵ | 10¹² | 10⁵ | 10⁵ | 10¹³ |
| housing section | | | | | | | |
| (Ω) | | | | | | | |

As is clear from the results shown in Tables 1 to 4, the increase in gasohol volume change rates of resin connectors of the Examples were very small compared to those of resin connectors of the Comparative Examples. Furthermore, the fuel permeation amounts of the resin connectors of the Examples were small as single-digit values, and therefore, it is clear that those have superior gasohol permeation resistance.

On the other hand, regarding the resin connectors of Comparative Examples, gasohol volume change rates were large and fuel permeation amounts exceeded 10 mg/unit/day, and therefore, it is clear that those have inferior gasohol permeation resistance.

As described above, the resin connector according to the present invention has a nearly cylindrical housing section in which one end portion is formed as the insert portion adapted to be inserted into the interior of a hose, and the other end portion is formed as the container portion to contain an engaging object member therein, and at least one seal member incorporated within the housing section. Furthermore, the aforementioned housing section is formed by molding of the resin composition having a volume change rate during immersion in gasohol of specified value or less. As a consequence, the whole connector has superior gasoline (gasohol) permeation resistance. Thus even if the connector is used for a fuel transport connection in an automobile using gasohol as a fuel, no problems occur in the use thereof.

When the aforementioned housing section is formed from a resin composition primarily containing at least one resin selected from the group consisting of polyphenylene sulfides, polybutylene naphthalates, hydrocarbons having a carbon number of 9 and including amines at both terminals-terephthalic acid condensates, hexamethylenediamine-adipic acid-terephthalic acid condensates, hexamethylenediamine-isophthalic acid-terephthalic acid condensates, hexamethylenediamine-adipic acid-isophthalic acid-terephthalic acid condensates, m-xylylenediamine-adipic acid condensates, and liquid crystal polymers, superior gasohol permeation resistance can be achieved.

What is claimed is:

1. A resin connector comprising:
a nearly cylindrical housing section having a first end portion formed as an insert portion adapted to be inserted into the interior of a hose, and a second end portion formed as a container portion adapted to contain an engaging object member therein; and
at least one seal member incorporated in the housing section,
wherein the housing section is a molding of a resin composition having the following property (A):
(A) a volume change rate during immersion in gasohol of 5% or less.

2. The resin connector according to claim 1, wherein the housing section is formed from a resin composition primarily comprising at least one resin which is a polymer resin or a copolymer resin having an aromatic in the principal chain thereof, and is selected from the group consisting of polyphenylene sulfides, polybutylene naphthalates, hydrocarbons having a carbon number of 9 and including amines at both terminals-terephthalic acid condensates, hexamethylenediamine-adipic acid-terephthalic acid condensates, hexamethylenediamine-isophthalic acid-terephthalic acid condensates, hexamethylenediamine-adipic acid-isophthalic acid-terephthalic acid condensates, m-xylylenediamine-adipic acid condensates, and liquid crystal polymers.

3. The resin connector according to claim 2, wherein the electrical resistance of the molding of the resin composition is 10⁶Ω or less.

4. The resin connector according to claim 1, wherein the electrical resistance of the molding of the resin composition is 10⁶Ω or less.
